(19) United States
(12) Patent Application Publication
(10) Pub. No.: US 2012/0221251 A1
(43) Pub. Date: Aug. 30, 2012

(54) SYSTEMS AND METHODS FOR SELECTING, ORDERING, SCHEDULING, ADMINISTERING, STORING, INTERPRETING AND TRANSMITTING A PLURALITY OF PSYCHOLOGICAL, NEUROBEHAVIORAL AND NEUROBIOLOGICAL TESTS

(75) Inventors: Saul Rosenberg, Greenbrae, CA (US); Lawrence M. Fagan, Los Altos, CA (US); Arthur M. Keller, Palo Alto, CA (US); Earl David Sacerdoti, Alamo, CA (US); Stanley E. Lieberson, Napa, CA (US)

(73) Assignee: NEURON VALLEY NETWORKS, Corte Madera, CA (US)

(21) Appl. No.: 13/402,687

(22) Filed: Feb. 22, 2012

Related U.S. Application Data
(60) Provisional application No. 61/445,039, filed on Feb. 22, 2011.

(51) Int. Cl. G06F 19/00

(52) U.S. Cl. 702/19

(57) ABSTRACT

A system comprises a validation module and an analysis module. The validation module is configured to receive input data from an electronic device operated by a test-taker during a biopsychosocial assessment. The input data includes a plurality of input terms that describes a functioning of the test-taker. The validation module is configured to validate the plurality of input terms based on a plurality of pre-defined terms stored within the system. The analysis module is configured to generate a list of potential biopsychosocial-related issues associated with the test-taker based on the validated input terms, and to generate a recommendation of one or more tests to administer to the test-taker based on this list. The analysis module is further configured to transmit an output signal representing the recommendation to an electronic device such that the one or more recommended tests are presented at an electronic device.

### CROSS REFERENCE TO RELATED APPLICATION

The present application claims priority to and the benefit of U.S. Provisional Application No. 61/445,039, entitled “Systems and Methods for Selecting and Interpreting a Plurality of Biomedical, Psychological and Neuropsychological Tests,” filed on Feb. 22, 2011; the disclosure of which is incorporated by reference herein in its entirety.

### BACKGROUND

The invention relates generally to systems and methods for the acquisition, processing, analysis and management of information from a plurality of psychological, neurobehavioral and neurobiological tests, measurements, and interviews (collectively “tests”). More specifically, the invention relates to systems and methods for selecting, ordering, scheduling, administering, storing, interpreting, transmitting and reporting information from a plurality of psychological, neurobehavioral and neurobiological tests.

Known decision support systems used in health care settings, referred to as “clinical decision support systems” are designed to influence clinical decision making about individual patients. Computer-based physician order entry systems, integrated with clinical decision support systems improve efficiency, accuracy and safety for ordering biomedical laboratory tests, procedures and medications. Such systems rely on machine-readable codes to uniquely identify each biomedical laboratory test, procedure or imaging study, etc. However, known systems do not include machine-readable codes for uniquely identifying a plurality of psychological and neurobehavioral tests. Known systems do not provide decision support for selecting and interpreting a plurality of psychological and neurobehavioral tests.

No currently known clinical decision support system provides terms, codes and vocabularies for psychological, neuropsychological and biopsychosocial informatics. Furthermore, currently known decision support system used outside of health care settings do not provide a single source for order entry and order fulfillment for a plurality of tests. Thus, a need exists for a system or method for assessing psychological and neurobehavioral and biopsychosocial functioning from impaired to superior for patients and for non-patients in various settings, such as, for example, healthcare settings, mental health care settings, sports settings, rehabilitation settings, educational settings, employment settings, civil litigation or criminal justice settings, and so forth.

No currently known systems or methods acquire, process, analyze and manage information from a plurality of psychological, neurobehavioral and neurobiological tests, including the selection, order entry, scheduling, administration, scoring, interpretation, storage and electronic transmission of information acquired from a plurality of tests. Additionally, no known decision support system provides an integrated, comprehensive single source or “one-stop-shopping” capability for selecting one or more tests, measurements, examinations and interviews, order entry, scheduling, administration, scoring, interpretation, electronic transmission, storage and results reporting pertaining to an individual at one point in time or for repeated measurements taken over days to years. Furthermore no known system provides the systems and methods to standardize the processes of psychological and neurobehavioral assessment so that test results obtained from any setting, for example, a state mental hospital or a primary care clinic are comparable. Thus, a need exists for a system and method with these capabilities.

Furthermore, no known decision support system incorporates the features of the invention to assess the range of psychological functioning from normal to exceptional. For example, the evaluation and screening of applicants for national and homeland security, defense, aviation and public safety requires the evaluation of normal to exceptional neurobehavioral and psychosocial functioning and the assessment of resilience to stress. No known decision support system has all of the appropriate tests (e.g., with unique identifiers and data standards) for acquiring, processing, analyzing, reporting and storing all the relevant test results. Thus, a need exists for a system and method with these capabilities.

### SUMMARY OF THE INVENTION

In some embodiments, a system comprises a validation module and an analysis module. The validation module is configured to receive input data from an electronic device operated by a test-taker during a biopsychosocial assessment. The input data can include a plurality of input terms that describes a functioning of the test-taker. The validation module is configured to validate the plurality of input terms based on a plurality of pre-defined terms stored within the system. The analysis module is configured to generate a list of potential biopsychosocial-related issues associated with the test-taker based on at least one validated input term. The analysis module is configured to then generate a list of one or more recommended tests to administer to the test-taker during the biopsychosocial assessment based on this list of potential biopsychosocial-related issues. The analysis module is further configured to transmit an output signal representing the list of one or more recommended tests to an electronic device such that the list of one or more recommended tests is presented at an electronic device.

### BRIEF DESCRIPTION OF THE DRAWINGS

FIG. 1 is a schematic illustration of a decision support system, according to an embodiment.

FIGS. 2A and 2B collectively illustrate a schematic block diagram of a decision support system and the processes thereof, according to an embodiment.

FIG. 3 is a screen shot of a test administration module of a decision support system, according to an embodiment.

FIG. 4 is a schematic block diagram of a process for selecting screening tests in a decision support system, according to an embodiment.

FIG. 5 is a schematic block diagram of a test administration process of a decision support system, according to an embodiment.

FIG. 6A is a schematic illustration of a diagnostic test table used by a decision support system, according to an embodiment.

FIG. 6B is a schematic illustration of a diagnostic test table used by a decision support system, according to an embodiment.

FIG. 7 is a screen shot of test questions used by a decision support system, according to an embodiment.

### DETAILED DESCRIPTION OF THE DRAWINGS

Methods and systems for selecting and interpreting a plurality of biopsychosocial tests are described herein. The terms “biopsychosocial test” or “biopsychosocial assessment”, as used herein, refers to one or more psychological tests, one or more neurobehavioral tests, one or more neurobiological tests, one or more biological tests (including medical tests and/or biomedical tests), and/or one or more social tests. A “biopsychosocial-related issue” can refer to a sign, symptom, condition, disease, disorder, impairment, diagnosis and/or the like affecting psychological, neurobehavioral, neurobiological, biological (including medical and biomedical), and/or social functioning. As will be discussed in more detail herein, the invention provides systems, methods, workflows, business processes and user interfaces for test-administrators, test-takers and test-interpreters. A system, such as a “decision support system,” can be integrated with computer-based order entry systems and computer-based testing systems, and used to automate the processes involved in testing, assessing and diagnosing individuals with various diseases, psychological and neuropsychological impairments and mental and/or substance use disorders and conditions. In some instances, the automated features of the system can allow certain individuals (e.g., a patient or a non-patient) to be tested and screened for neurobehavioral and mental impairments and disorders remotely. For example, when an individual is a military service member injured in combat, that injured individual can be tested and screened for neurobehavioral and mental impairments and disorders by capturing data in the field and relaying it back to field stations, medical clinics in theatre and relayed by satellite to military hospitals, academic medical centers and military research centers where all prior testing for that individual would be available (e.g., baseline neurobehavioral and psychosocial functioning from pre-deployment).

In some embodiments, the invention provides for a system, method, workflow, business process and user-interface for every step of the assessment process including test selection, computerized order entry of the test, display of the test on a computer or mobile device, test administration, electronic transmission of the test responses and raw data for local or remote processing, scoring, interpretation, storage, and results reporting. Thus, the invention provides an integrated and comprehensive single source for testing and assessment services providing efficiency and comparability of test results across individuals and across diverse settings.

The following is an example of how the system (e.g., a decision support system) can be used by a primary care physician to screen and diagnose psychological factors affecting a chronic disease. A woman, who is exhibiting symptoms of depression, makes a doctor's appointment. The woman has controlled diabetes and has been living on her own since her husband died. The nurse (i.e., the “test administrator”) observes that the patient (i.e., the “test-taker”) looks more tired and sad than usual and is poorly groomed, which is uncharacteristic of the woman. The nurse can initiate the system by gathering information about the woman's symptoms and complaints and observation of the patient. The nurse clicks, points or inputs in any manner from a drop down menu, the symptoms “tired” and “depressed.” The system determines the probabilities of different diagnoses, for example Major Depression. Once the diagnostic question is identified, the system returns the differential diagnoses, which include depression and sleep disorder, and a drop down menu of psychological tests and patient-reported health measures. These can be used as screening test to quantify and categorize the nature of the depression and or sleep disorder, the severity of symptoms, the amount of time the symptoms are present and other attributes. The screening tests can help pinpoint certain potentially problematic health issues using information provided by the patient that relate to, for example, sleeping patterns, pain, and/or other problematic symptoms (e.g., depression or anxiety). In some instances, however, a screening test may not be necessary. The nurse in this instance may recognize that the woman has symptoms of depression and instead proceeds directly to ordering a diagnostic test for depression. The diagnostic test can be administered using a computer or mobile device (e.g., a tablet computer). The diagnostic test can also be administered on paper, where the woman completes the test by hand and then the results are scanned or otherwise entered into a computer program. A computer program scores the screening test and the results are immediately reported to the clinician and at the same time reported to the patient. The psychological tests administered are all standards-based to facilitate the sharing of information among clinicians for continuity of care.

The results generated by the system in the above example can also provide additional diagnostic information beyond the basic diagnosis of depression. For example, the system can compare the woman's test results to other like individuals (e.g., sex, age, etc.) having undergone the same diagnostic test. In the current example, the results show that the woman tested in the 90^{th} percentile—meaning, she reported more depression that 90% of the women her age. The system provides clinical practice guidelines for evidence-based treatment of depression. For example, the system can compile a list of the most effective treatments for the woman's depression, including medication(s), cognitive therapies, exercise, diet and the full range of interventions for treating depression. The nurse can pass all of this information along to the patient's physician before s/he even enters the examination room. The information can be provided to the patient in printed form or sent to patient's personal health record or other computer device. The patient is provided with informed consent forms to be able to exercise control over her own personal health information. In addition to meeting the Privacy Rule under the Health Insurance Portability and Accountability Act (HIPAA), protection is included in the system for the electronic transmission of personal health information pertaining to mental health and substance use.

The system can also be used to assess individuals outside of health care settings. For example, the system can be used to psychologically assess individuals who apply to work in occupations critical to national and homeland security and safety (e.g., military services, civilian first responders, air traffic controllers, nuclear plant operators, airline pilots and criminal justice services). At the time these individuals apply to work in these high-stress occupations, they are generally not patients; however, they may become patients at a later time (e.g., in the line of duty) due to the risk of these occupations. The system can perform psychological assessments to determine if, for example, an individual is especially resilient or especially vulnerable to certain kinds of stress. In some instances, the system can perform psychological assessments to identify those individuals who may be especially vulnerable to deployment stress and refer them to resilience training. The system can further recommend training, education or interventions to assist applicants in improving the cognitive and psychological functions necessary to be employed in that occupation or to otherwise be resilient under stressful work conditions. The system can also assess individuals who are already assigned to a particular job or duty, including continuously monitoring or periodically assessing an individual's performance against a benchmark. Said another way, the systems and methods described herein can assist in the assessment of vocational functioning, suitability for employment, fitness-for-duty and job performance. The psychological and neuropsychological assessment(s) performed by the system can also be applied in other occupational and educational settings where the individual is not a patient. For example, the system can be used in personal injury litigations (e.g., to determine if a plaintiff has Posttraumatic Stress Disorder due to a defendant's conduct).

Biopsychosocial assessment of criminal defendants and terrorist suspects can be used to evaluate if such individuals have diminished mental capacity and is capable of standing trial and other issues related to the criminal justice system. Analysis of audiovisual recording, voice stress test analysis and non-invasive physiological monitoring of heart rate, blood pressure and other biomarkers can evaluate criminal defendants and terrorist suspects. These and other examples are described in more detail below.

In some embodiments, the invention provides decision support to assist clinicians with screening, diagnosis, treatment, rehabilitation and prevention planning, case monitoring and treatment outcome evaluation. In some embodiments, the systems and methods described herein provide for assessment of psychosocial and neurobehavioral functioning and health and assessment of neurocognitive, mental and substance use conditions, disorders and disabilities. In some embodiments, decision support is provided for planning treatment, rehabilitation and prevention of chronic diseases and mental disorders. In some embodiments, decision support is provided for measuring a patient's adherence to treatment, including diet and exercise, and for measuring the effectiveness, outcomes, benefits and costs of treatment, rehabilitation or prevention for a particular individual. In some embodiments, the comparative treatment effectiveness of different treatments can be evaluated. For example, patients who are pre-diabetic can be randomly assigned to different treatments to prevent diabetes. The system can provide decision support to purchasers of health care, including for value-based purchasing. Moreover the system can provide metrics to compare the cost of preventing diabetes—and the cost of not preventing diabetes. Thus the system can be used for population health promotion efforts. In some embodiments, the systems and methods provide for repeated measurement of an individual's psychological and neurobehavioral status over time, including the measurement of outcomes, benefits, quality and value of health and human services and for clinical and translational research. In these particular embodiments, the system (and its corresponding methods) can be referred to as a “decision support system,” a “clinical decision support system,” or an “executive decision support system”.

In some embodiments, the invention provides systems and methods for the assessment of vocational functioning, suitability for employment, fitness-for-duty and job performance. The system here can be referred to, for example, as an “employment decision support system.” In some embodiments, the invention provides systems and methods for assessment of disability for veterans and for state and federal and private disability programs. The system here can be referred to, for example, as a “disability decision support system.”

As used herein, the terms “assessment” or “test” (or any variation thereof) can refer to a measurement, recording or observation. The systems and methods described therein can acquire, process and/or analyze data regarding biological, psychological and social functioning, which can be referred to collectively as “biopsychosocial functioning”. Assessment or testing may be understood to include one or more psychometric tests, scales, inventories, interviews, audiovisual recordings, monitoring or imaging devices, and any method of quantifying and categorizing psychological, neurobehavioral and neurobiological functioning, impairments, disorders, conditions and disabilities. Psychological tests and assessments include any procedure used by a psychologist physician, psychiatrist, social worker, nurse, counselor or qualified professional to acquire information about any psychological, mental or substance use condition or disorder.

As used herein, the term “test-taker” refers to an individual that is subject to psychological assessment or testing and/or neuropsychological assessment. A test-taker can be a patient or a non-patient. For example, a test-taker can be an employee, a military service member, a civilian first responder, homeland security personnel, a disability claimant, a plaintiff or defendant in a civil litigation a criminal defendant, a recipient of health and human services, and/or the like.

As used herein, the term “Administrator” refers to one or more individuals that screen, assess, diagnose, plan treatment, plan rehabilitation, monitor progress of and/or assess outcomes for one or more test-takers. In some embodiments, the Administrator is an individual(s) that is qualified to obtain clinical information, such as, a clinician, a psychologist, a physician, and/or a nurse. In some embodiments, the Administrator does not need such qualification(s) and can be any suitable individual(s) that administers tests and the like. For example, the Administrator can be a mental health professional, a disability, vocational, or rehabilitation professional, a civil or criminal justice professional, and/or any other health services or human resources professional.

As used herein, the term “Test Interpreter” is an individual qualified to integrate data from multiple tests with additional information about the person and the evaluation context who makes a decision, recommendation or evaluation about the test-taker. In one embodiment, a test interpreter can be a doctor or other qualified clinician.

As used herein, “standards” refers to specifications designated as a standard for use in U.S. Federal Government systems. For example, SNOMED Clinical Terms® (SNOMED CT®) (Systematized Nomenclature of Medicine—Clinical Terms) is a comprehensive clinical terminology designated as a standard for use in U.S. Federal Government systems for the electronic exchange of clinical health information and is also a required standard in interoperability specifications. Another designated standard, Logical Observation Identifiers Names and Codes (LOINC®) uniquely identifies biomedical laboratory tests, radiological studies, and a small sub-set of psychological tests. The Health Insurance Portability and Accountability Act (HIPAA) Privacy Rule established national standards to protect individuals' medical records and other personal health information. The International Classification of Diseases, Ninth Revision, Clinical Modification (ICD-9-CM), developed by the World Health Organization, is the official system of assigning codes to diagnoses and procedures associated with hospital utilization in the United States. As new standards are released and mandated by the U.S. Federal Government, for example, ICD-10, information systems are updated to reflect the latest version. In other countries or in systems other than for use by the U.S. Federal Government, as well as in contexts other than medicine, other standards may exist and be used. In addition, predecessors and successors to these standards are also included.

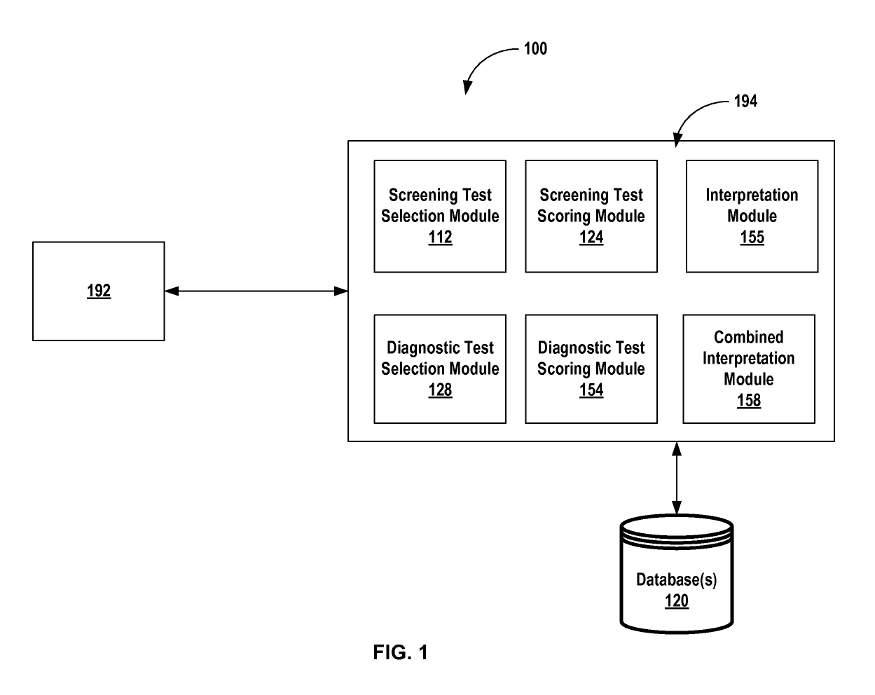

FIG. 1 is a schematic block diagram of a decision support system 100. As will be discussed in more detail herein, the decision support system 100 can be configured to screen a test-taker for mental and neurobehavioral impairments, conditions and disorders; to assess psychological factors affecting a medical condition of the test-taker; to assess the test-taker's psychological functioning, health and/or disabilities; to assist Administrators (e.g., health care providers) with screening, differential diagnosis and/or treatment planning; to assist clinical and translational researchers (e.g., to provide test data to these individuals for research purposes); to assist Administrators (e.g., clinicians) and test-takers (e.g., patients) with treatment, rehabilitation and prevention planning, comparative treatment effectiveness research, measurement and/or reporting of quality and/or value of health care services; to identify and monitor drug use; to manage randomized clinical trials and prospective cohort studies; to provide decision support for quality assurance managers and/or value-based purchasing of health care services; and/or the like. The decision support system can perform any one of these duties or functions alone or in conjunction with another system or device.

As shown in FIG. 1, the decision support system 100 includes a front-end system 192 and a back-end system 194. The front-end system 192 is configured to communicate with the back-end system 194. In some embodiments, the front-end system 192 is configured to communicate with the back-end system 194 via a wired connection. In some embodiments, the front-end system 192 is configured to communicate with the back-end system 194 via a wireless network (e.g., the Internet, an intranet, the VA, DoD and/or military health networks). Other possibilities for transmission of information and data between the front-end and back-end systems 192, 194 include Hypertext Transfer Protocol (HTTP), File Transfer Protocol (FTP), Wireless Application Protocol (WAP), TCP/IP communication protocol, a connection-oriented or connectionless network protocol, asynchronous transfer mode (ATM) technology, X.25 protocol, Frame Relay protocol, packet switching protocols, circuit switching protocols, dynamic packet switching protocols, 802.11 wireless protocol, IR, RF, blue tooth transmission, cable modem, ADSL connection, ISDN, Ethernet, or various other communication protocols for continuous or intermittent connectivity over a wireless or wired network, a cellular network, satellite, or comparable networks or communication line connections, or a combination of these or similar networks. Additionally, the front-end and back-end systems 192, 194 can compress, decompress, encrypt, decrypt, de-identify, re-identify, packetize or recombine data and perform other like functions associated with data transmission.

In some embodiments, the front-end system 192 and the back-end system 194 are co-resident or co-located on a single computer system (such as a desktop, laptop or tablet computer). In some embodiments, the front-end system 192 and the back-end system 194 are separate from each other (e.g., front-end system 192 can reside on a separate device or devices from the back-end system 194). The front-end system 192 can be disposed in one location (or device) or distributed among multiple locations (or multiple devices). Likewise, the back-end system 194 can be disposed in one location (or device) or distributed among multiple locations (or multiple devices). For example, the back-end system 194 can be divided among multiple computer systems, such as a collection of Internet servers. In embodiments where the front-end system 192 is separate from the back-end system 194, the two systems 192, 194 can be connected and communicate via a network. The back-end system 194 may be an integrated system or include services provided by multiple entities. For example, language translation services provided by others may be used by the back-end system 194.

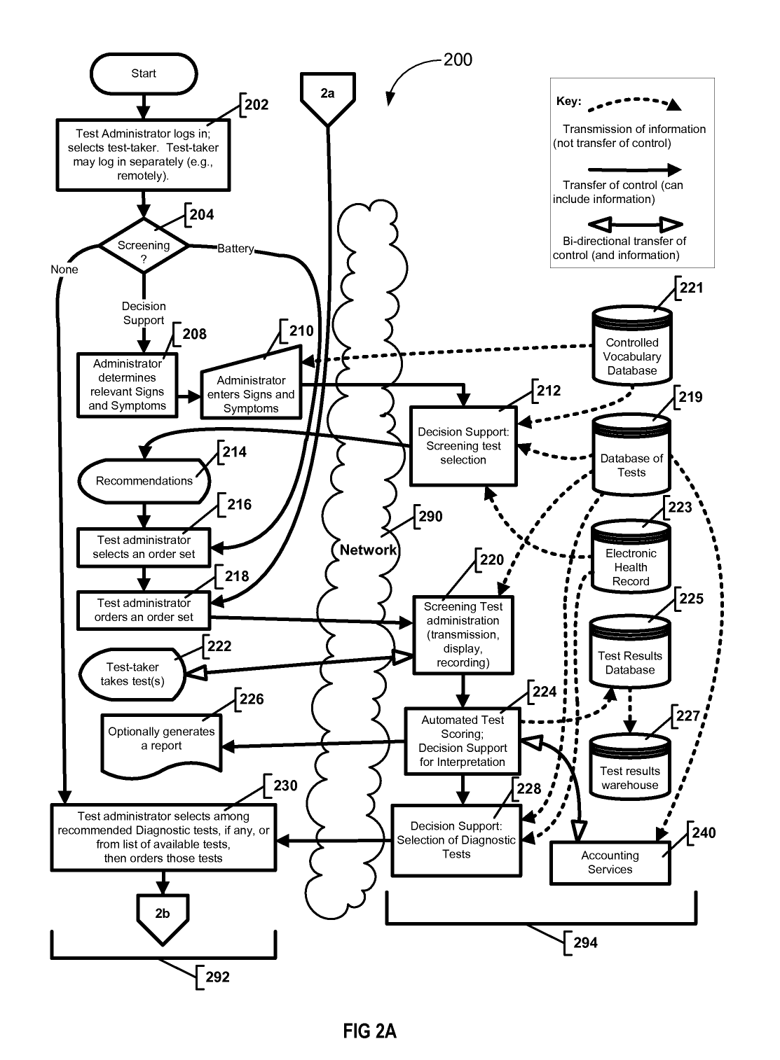

The front-end system 192 can include software and/or one or more computer programs implemented on a computer, a smartphone, a tablet computer, a cellular phone and/or other device capable of entering, displaying, or otherwise presenting data. In some embodiments, the front-end of the system 192 can include a graphical user interface (GUI) configured to be displayed on a screen, such as a computer monitor at, for example, a clinician's office, a computer tablet in a waiting room, or a smartphone at a remote location or otherwise presented. As will be described in more detail in FIGS. 2A-2B and herein, a user (e.g., an Administrator or a test-taker) can interact with the decision support system 100 via the front-end of the decision support system 192 (e.g., via a GUI). In some embodiments, this interaction can be through voice response. Data can be entered or input into the system 100 via a keyboard (e.g., typing), pushing buttons, tapping on a screen, speech, or by interaction through accessible interfaces, such as sip-and-puff or eye gaze, or comparable input interfaces. User prompts or responses can be entered or input into the system 100 in textual form, symbolic form, graphically, via computer-generated speech (e.g., using tones or music), via accessible interfaces (e.g., Braille), and/or the like. Data can be output from the system 100 and displayed for a user via a display screen (e.g., computer monitor), projected on a screen, or in printed form, or presented via suitable output interfaces (including accessible interfaces). In some embodiments, the system 100 includes multiple front-end systems used concurrently by more than one user (e.g., one front-end system 192 can be used by the test-taker and another front-end system 192 can be used by the Administrator). In other embodiments, however, the test-taker and Administrator share a single front-end system 192.

The back-end system 194 of the decision support system 100 can include one or more storage media (or other storage devices), one or more servers and/or other hardware devices configured to transmit, receive, store and/or manipulate data. For example, these hardware devices can store back-end software applications, programs or modules (e.g., a module of computer code to be executed in hardware, including software as firmware, or a set of processor readable instructions stored in memory and to be executed in hardware) that execute one or more functions of the decision support system 100. Individuals monitoring and/or maintaining the decision support system 100 can access and/or update data within the decision support system 100 via the back-end system 194 in any suitable manner.

As shown in FIG. 1, the back-end system 194 includes a screening test selection module 112, a screening test scoring module 124, a diagnostic test selection module 128, a diagnostic test scoring module 154, an interpretation module 155, and a combined interpretation module 158. These modules 112, 124, 128, 154, 155 and/or 158 can be inter-related and configured to communicate with each other, as discussed in more detail herein. Although the back-end system 194 is illustrated in FIG. 1 and described as being divided into six modules, in other embodiments, the back-end system 194 can be divided into any number of modules or segments configured to perform one or more specific functions. In some embodiments, the back-end system 194 and/or any of the modules therein can access one or more databases 120.

The screening test selection module 112 is configured to receive input from an Administrator or test-taker at the front-end system 192, and then select one or more screening tests to administer to that test-taker. As will be described in detail herein, the screening test selection module 112 can access a database of screening tests (120) and select a screening test from those available in that database. The screening test selection module 112 can use any methodology described herein for selecting the appropriate screening tests to administer to the test-taker. The screening test selection module 112 can then send a list of recommended screening tests to the front-end system 192, as described herein.

The screening test scoring module 124 is configured to score a completed screening test. More specifically, the screening test scoring module 124 can receive the test-taker's responses to a screening test, and then calculate a score for the test-taker. The screening test scoring module 124 can grade or calculate the score using any methodology described herein. In some embodiments, the screening test scoring module 124 can access a database (120) that contains test scores from other individuals that have taken the same screening test, and then compare the test-taker's score to the stored scores.

The diagnostic test selection module 128 is configured to select one or more diagnostic tests to administer to the test-taker at the front-end system 192. In some embodiments, the diagnostic test selection module 128 is configured to select a diagnostic test based on the results of the screening tests. In this embodiment, the diagnostic test selection module 128 can access a database (120) of diagnostic tests and then select a diagnostic test from those available in that database. The diagnostic test selection module 128 can select the appropriate diagnostic test using any methodology described herein. In some embodiments, however, the diagnostic test selection module 128 can receive a request signal for a specific diagnostic test so that no filtering or other selection process is necessary. In this embodiment, the diagnostic test selection module 128 merely retrieves the diagnostic test from, for example, a database (120) of diagnostic tests, and sends the diagnostic test to the front-end system 192.

The diagnostic test scoring module 154 can operate and function in the same manner as the screening test scoring module 124, except the diagnostic test scoring module 154 scores, grades, calculates, compares, etc. completed diagnostic tests as opposed to screening tests. The diagnostic test scoring module 154 can similarly access a database (120) that contains test scores from other individuals that have taken the same diagnostic test, and then compare the test-taker's score to the stored scores.

The interpretation module 155 is configured to analyze the results generated by the diagnostic test scoring module 154 and/or the screening test scoring module 124. The interpretation module 155 can analyze or interpret the test scores using any methodology described therein. As will be described in more detail herein, the interpretation module 155 can generate and send the results of the screening and/or diagnostic tests to the front-end system 192 as a score report. In some embodiments, the interpretation module 155 recommend additional diagnostic tests to administer to the test-taker based on the test results the interpretation module 155 has already received.

The combined interpretation module 155 is configured to analyze the results generated by the diagnostic test scoring module 154 and/or the screening test scoring module 124, along with other information available about the test-taker. For example, the combined interpretation module 155 can access a database (120) that contains the test-taker's medical information, and then analyze the test results based on the test-taker's medical history to produce a combined interpretation. The interpretation module 155 can also access a database (120) that contains prior test results (e.g., the test scores from screening and/or diagnostic tests that the test-taker has taken in the past), and then analyze the current test results and the past test results to produce a combined interpretation. The combined interpretation module 155 can analyze or interpret the test scores along with any other relevant and available information pertaining to the test-taker using any methodology described therein.

An example of how the decision support system 100 (and its corresponding sub-systems 192, 194 and modules) can operate and function is illustrated and described in FIGS. 2A and 2B. FIGS. 2A and 2B illustrate a schematic block diagram of a decision support system 200 and the processes thereof. The decision support system 200 includes a front-end system 292 and a back-end system 294 similar to that described above with respect to FIG. 1. FIG. 2A specifically illustrates and describes the portion of the decision support system 200 concerned with selecting and ordering screening tests. FIG. 2B specifically illustrates and describes the portion of the support system 200 concerned with administering diagnostic tests, interpreting the results, and generating corresponding reports.

As shown in FIG. 2A, the testing process begins at block 202 when an Administrator or a test-taker accesses the decision support system 200. The Administrator and/or test-taker can, for example, log onto the decision support system 200 via a GUI or other terminal/interface executed at the front-end system 292. In some embodiments, access to the decision support system 200 or the front-end system 292 is password protected and/or requires an authentication process to validate the identity of the person attempting to access the system. In some embodiments where the test-taker can access the decision support system 200, the Administrator is required to access the system 200 (or 292) and identify the test-taker before the test-taker is provided access to the system 200 (or 292). In other such embodiments, the test-taker is able to access the system 200 (or 292) directly without such prior identification. Testing can take place, for example, in a hospital, a clinic, an office, and/or any other setting described herein.

In some embodiments, the test-taker can log into the system 200 (or 292) remotely via an authentication process and/or password and therefore does not need to be physically present at the Administrator's site (e.g., a doctor's office) to be evaluated/assessed by the decision support system 200. The test-taker can be evaluated/assessed, for example, in his or her own home using a personal computer, a mobile device, or a like device with the decision support system's 200 computer program (e.g., GUI) loaded thereon or otherwise provided to the test-taker in an appropriate user interface format. Remote access to the decision support system 200 can be particularly useful for assessing and/or treating Medicare beneficiaries or the elderly, who may be housebound, or living in assistive living facilities or nursing homes. The Administrator can interview and/or test these individuals remotely through teleconferencing (e.g., telemedicine) and/or other suitable telecommunications. In some embodiments, at least a portion of the front-end system 292 can be implemented in the form of a webpage or website so that the Administrator and/or test-taker can access the decision support system 200 over an Intranet, or over the Internet at any location.

Returning now to FIG. 2A, at block 204, the decision support system 200 gives the Administrator the option to (i) use the back-end system (294) to select a screening test 208, (ii) skip screening tests and go directly to diagnostic test selection 230, or (iii) skip the screening test and go directly to ordering a pre-set test battery 216. Blocks 230 and 216 are described in more detail below.

The Administrator can choose to use the back-end system (294) when, among other reasons, it is not readily apparent to the Administrator which screening test or tests should be administered to the test-taker. When using the back-end system, the Administrator (or test-taker) can take note of a pre-existing health-related issue or an issue related to the purpose of the office visit and input one or more signs and/or symptoms into the GUI at the front-end system 292 at block 210. The Administrator (or test-taker) can, for example, input one or more of the following into the GUI: a complaint, a symptom, a physical, mental and/or substance abuse condition, impairment, disorder and/or disability, a previous diagnosis, family history, social and cultural factors. Such inputs are hereafter referred to collectively as “signs”, symptoms” or just “measures.” In some embodiments, the Administrator can input 210 symptoms directly into the system via a text box (for example, words like “tired,” “sad,” or “nervous”) or can select symptoms from a list provided by the user interface (for example, via a drop down menu).

In some embodiments, the Administrator can access the test-taker's Electronic Health Record (EHR) 223, and/or other sources of health data via the system 200. The EHRs 223 can be stored within the decision support system 200 (e.g., within a database), or can be provided to the decision support system 200 from an external source. In the same manner, the test-taker can have access to his or her EHRs 223 and/or other information resources via the decision support system 200 (or other program). In some embodiments, the Administrator and/or the test-taker has limited or no access to external sources of information via the decision support system 200 and therefore may be unable to access the EHRs 223 and other information sources and resources if they are stored outside of the system 200. In some embodiments, the information from the patient's EHRs 223, or any other source, is obtained without a specific request by the Administrator, but may be an automatic process of the system 200 once the test-taker is identified. Other information about the test-taker may be used, particularly but not exclusively in non-medical settings, such as criminal records, employee records, educational records, legal records, job performance records or information gleaned from social networking sites or Internet searches.

Once the signs, symptoms psychological and neurobehavioral, descriptions are input into the front-end system 292, they are electronically transmitted 292 to the back-end system 294. At the back-end system 294, the identified/selected terms are converted to and/or associated with codes, vocabularies and terminologies (collectively referred to as “terminology services”). The resulting converted/associated terms are then analyzed to determine which categories of psychological and neurobehavioral functioning, physical and mental impairments, disorders, conditions, disabilities and/or diagnoses correspond to some or all of those identified/selected sign, symptoms and behavioral descriptions. The processes of converting/associating, analyzing and/or determining can be performed, for example, by the screening test selection module 212. The term “screening” as used herein refers to any brief assessment to determine an initial or baseline status and to determine if more comprehensive, lengthy and more costly tests are necessary to make a diagnosis or determine a particular kind of psychological, neurobiological or neurobiological functioning. The screening test selection module 212 can operate as a separate decision support system or sub-system of the system 200. In some embodiments, one or more processes for associating terms are performed by another module separate from the screening test selection module 212.

As shown in FIG. 2A, the decision support system 200 can include terminology services and/or a controlled clinical vocabulary database 221 (or other aptly named database for storing a pre-defined vocabulary) that stores data related to the controlled vocabulary related to the system 200. The terminology services and/or the controlled vocabulary stored within database 221 can include a list of words or phrases (referred to herein as “terms”) with known meanings that can be used to represent signs, symptoms, conditions, diseases, disorders, personality traits, cognitive measurements, etc., of the test-taker. The signs, symptoms, conditions, behavioral descriptors etc., can be entered in the front-end system 292 (e.g., via a tablet computer) using common phrases, which are then converted to the corresponding terms in the controlled vocabulary. These common phrases can be entered into the front-end system 292, for example, via a textbox of a GUI or in any other manner described herein. In some embodiments, a narrative is entered, and the system 200 (e.g., via the screening test selection module 212) chooses terms in the controlled vocabulary database 221 corresponding to the narrative by interpreting the narrative. In some embodiments, the Administrator and/or test-taker choose codes and terms from a pre-defined list (e.g., including controlled vocabulary or subsets of the controlled vocabulary). There may be multiple pre-defined lists of terms, and codes from multiple domains, for example vocabulary used in the International Classification of Functioning, Disability and Health, or the International Classification of Diseases, published by the World Health Organization.

In some embodiments, the decision support system 200 does not include the controlled vocabulary database 221. Rather, in some embodiments, the controlled vocabulary is stored or otherwise represented as a list (e.g., in a computer file), or as a decision tree. In some embodiments, the back-end system 294 is configured to access a controlled vocabulary database that exists outside of the system 200 (e.g., a database maintained by a third-party). In some embodiments, the controlled vocabulary is part a knowledge base.

Once the controlled vocabulary for the relevant signs and symptoms are identified, the screening test selection module 212 (or another component of the back-end system 294) can access a database of tests 219 and make a determination as to which screening tests are available and appropriate for administration to the test-taker.

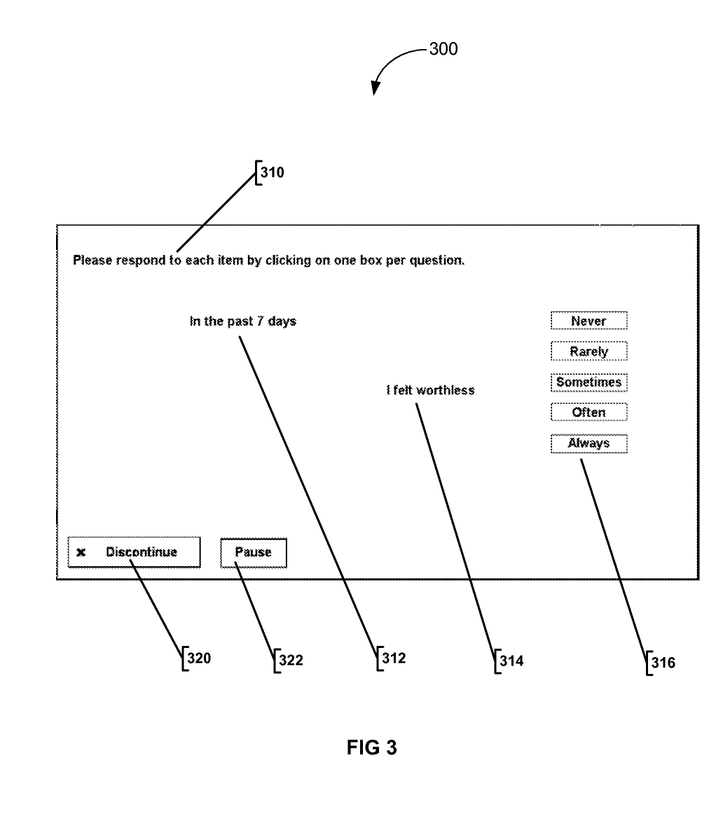

In some embodiments, the screening test selection module 212 (or another component of the back-end system 294) identifies the appropriate screening tests using one or more classification methods. The associations between inputs (such as signs/symptoms) and outputs (such as test names) can be described using techniques such as a look-up-table with or without an entry for a measure of belief or certainty. Alternatively, knowledge-based models such as production rule systems or ontological networks with logic formalisms can be used to describe the associations. Alternatively, statistical methods, such as Logistic Regression, CART, Naive Bayes, Bayesian Belief Networks, Support Vector Machines, and Random Forests, can be used to describe the associations, or a combination of these methods. For example, screening test selection module associates one or more terms provided by the test-taker, such as “depressed” with a screening test entitled “DEPRESSION (8 item).” The associations may be derived from expert opinion, be determined by natural language processing of the scientific literature, or learned from databases using supervised or unsupervised machine learning techniques. The choices of mechanisms for implementing test selection module 212 are comparable to the choices of mechanisms for implementing other modules, including decision support module for scoring 224, diagnostic test selection module 228, decision support module for the scoring and interpretation of diagnostic tests 254, and the decision support module for ordering additional tests 270, described further below. Details regarding how the decision support system 200 and/or the screening test selection module 212 selects screening test will be discussed with respect to FIG. 4.

A list of potentially relevant screening tests are transmitted from the back-end system 294 (e.g., via the screening test selection module 212) to the front-end system 292 and are displayed 214 on a GUI (or otherwise presented) for review by an Administrator. Said another way, the decision support system 200 can generate and provide the Administrator with a list of “recommended” screening tests that were selected based on the signs and symptoms that the Administrator previously provided. In some embodiments, the transaction of sending identified/selected symptoms and receiving a list of screening tests can occur, for example, in real-time and in a matter of seconds or milliseconds. The Administrator can select 216 and order 218 any one of the screening tests on the presented list for the test-taker to take. For example, the Administrator can select either all of the recommended screening tests, a subset of these tests, or none of the recommended screening tests. The screening tests may be selected by the Administrator in any suitable manner that provides for the selection of zero or more entries from a group (e.g., via a check box). The list of selected screening tests is then transmitted from the front-end of the decision support system 292 to the back-end of the decision support system 294.

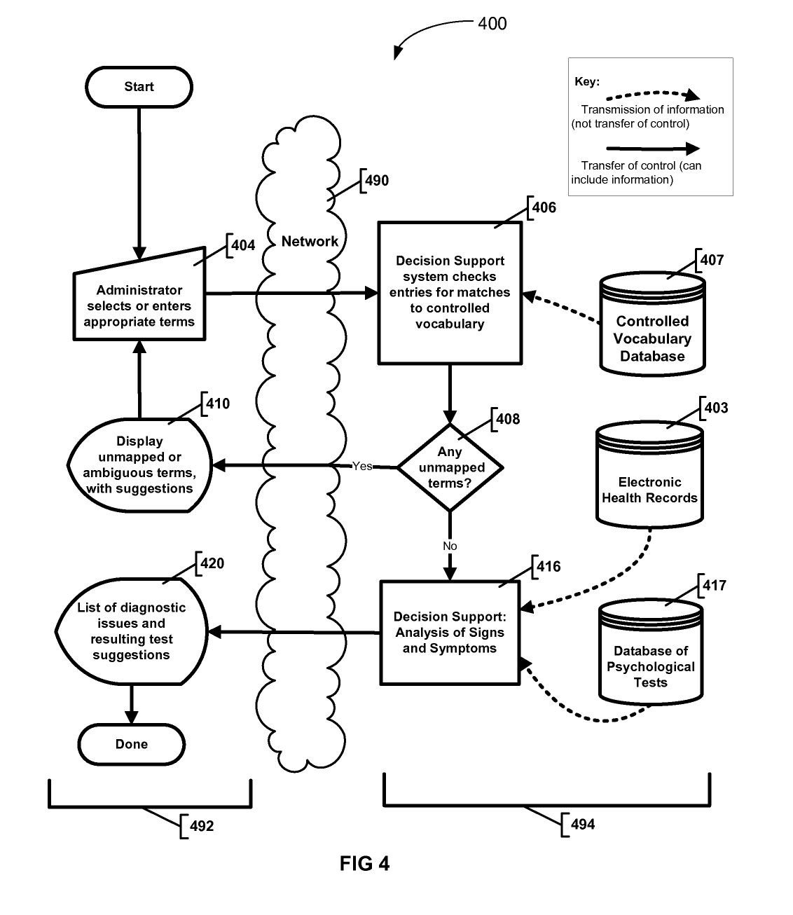

The ordered screening tests are administered to the patient 220. Some embodiments for administration of one or more tests is illustrated and described further in FIG. 5.

The test-taker can take the screening test electronically (e.g., using the GUI 222), manually (e.g., a handwritten test that can be scanned in or manually entered into the GUI or program), or orally (e.g., the Administrator or an individual delegated by the Administrator can record the answers by hand for subsequent scanning or other entry, or may directly enter the answers into the GUI 222 or program; optionally, the program can accept spoken recordings or accept inputs from a telehealth or other remote system in instances where an Administrator and test-taker are not co-located). The test-taker's responses are then forwarded to the decision support system at the back-end of system 200 for analysis 224.

The Decision Support Module for Scoring 224 takes measurements related to the test-taker and associates those measurements with a type of summary of the measurements. Typically, the inputs are questions responded to by the test-taker that are associated with a specific response code. This is used for both screening tests and diagnostic tests: For example, the test-taker responds to test questions (question: “feel depressed?” response: “most days”; associated with response score=4); the score of each selected response is summed to calculate the raw score. The raw score is matched against a (test-specific) table for a particular population that the tests were standardized on, e.g. patients over 65 matched to the U.S. census for ethnicity, that converts raw scores to standard scores (one popular procedure, the “T-Score” has a mean of 50 and Standard Deviation of 10). In a “normal distribution” of scores, also referred to as a “bell-shaped curve,” a score of 70, that is two standard deviations above the mean, converts to the 98th percentile which means that the test-taker scored in the depression screening example, endorsed more depressive symptoms than 98% of a community sample. Alternatively, measurements can include responses to a cognitive test such as reaction time, by comparing an individual's score to a representative non-patient sample in the community, or by comparing a neurobiological marker of stress such as cortisol to a particular population, e.g. military service members undergoing basic training.

Completed tests are scored and interpreted 224 at the back end of the decision support system 294, and the results are stored in the database of test results 225. The decision support module takes a set of inputs from the test-administrator, such as words or phrases, such as “depressed,” that describe the test-taker's behavioral status. The decision support module can associate those inputs with a set of outputs, such as another set of categories or scores that describes the test-taker's status. In some embodiments, the administered and scored test items can be transmitted to accounting services 240. Accounting services may include invoicing or other accounting functions. Accounting services may include auditing, quality control, utilization review and interfacing with payers, (Medicare, insurance companies). In some embodiments, following screening test scoring 224, a report 226 on the outcome of the tests is generated. In some embodiments, the Administrator can also select the type of one or more reports to be sent back to the Administrator and/or test-taker once the results of the screening test are calculated. In the preferred embodiment, following scoring and interpretation of the screening tests, a diagnostic test selection module 228 then generates a list of the suggested diagnostic tests and transmits it to the front-end of the system, where it is presented 230 to the Administrator.

When diagnostic tests have been selected 230, whether directly by the Administrator (204) or as a result of screening test results 228, these diagnostic tests are administered 250 via a display device 252 or using another user interface, as discussed earlier. In the preferred embodiment, completed tests are automatically scored and interpreted 254. In some embodiments, the results are reported to Accounting Services 240.

In some embodiments, following diagnostic test scoring and interpretation 224, Combined Interpretation module 258 is used to review the set of test results, along with any other available health information about the patient 223 to produce one or more reports 260 on the combined testing. For example, a decision support module for selecting screening tests for depression associates one or more terms provided by the test-taker, such as “depressed” or “down” or “tired” with a recommendation for a screening test entitled “DEPRESSION (8-item).”

The Decision Support Module for Screening Test Selection 212 associates the test-taker's self-report, the Administrator's observations and rating, or both, with one or more screening tests. For example, the test-takers description “tired” or the related mapped code may be associated with the screening test named “DEPRESSION (8-items).” In another example, the terms “sad,” “daytime sleepiness,” and “insomnia” or their related mapped codes can be associated with the screening tests “Sleep Disturbance (8-items); Sleep-Related Impairment (8-items); Fatigue (8-items).”

Screening tests are used to recommend whether additional, more definitive tests are necessary to make a diagnosis. The Decision Support system for the Selection of Diagnostic Tests 228 associates conclusions about the interpretation of screening tests with the names of recommended diagnostic tests and structured clinical interviews to perform. For example, a conclusion of a “positive screen for depression” could be associated with a recommendation for the diagnostic tests named “Depression (28-item) and a semi-structured clinical interview, the “Structured Clinical Interview for DSM-IV Axis I Disorders—Major Depressive Episode Criteria. In some situations, the inputs can be the test-taker's responses directly rather than screening test results.

The Decision Support Module for the Scoring and Interpretation of Diagnostic Tests 254 first scores the diagnostic tests, and then associates scores on the diagnostic tests and or structured clinical interviews with one or more conclusions about the test-taker's state. For example, if the Depression (28-item) test score is at the 98th percentile, or the Structured Clinical Interview for DSM-IV Axis I Disorders—Interview for Major Depressive Disorder reports a “positive diagnosis for Depression” then conclude that the test-taker is “Positive for DSM diagnostic criteria for Major Depressive Disorder,” or positive for ICD-9, 10, 11 diagnostic criteria for Major Depressive Disorder. In some situations, the inputs are the terms used by the test-taker directly and the output is the test-taker's state.

The Decision Support Module for Test Integration and Assessment 258 associates scores on multiple diagnostic tests with one or more conclusions about the test-taker's state. For example, DEPRESSION (28-item) test the summed raw score translates to the 98^{th} percentile AND Structured Interview for Major Depressive Disorder and screening test for POSTTRAUMATIC STRESS DISORDER (PTSD) (12-item) AND Clinician Administered Scale for Posttraumatic Stress Disorder (definitive, “gold standard” structured interview for PTSD) with summary ratings for different aspects of Posttraumatic Stress Disorder and a dichotomous rating, “positive for Posttraumatic Stress Disorder.” If the test-taker has been exposed to traumatic event, for example, injury during military combat, and the diagnosis for depression is positive, then conclude that the test-taker's diagnosis is Posttraumatic Stress Disorder with co-occurring or “co-morbid” Major Depressive Disorder with recommendations including but not limited to: test for social support, test for alcohol and related disorders, test for suicide risk, recommend interventions based on evidence-based clinical practice guidelines. Said another way, if an individual has a positive score for depression and in addition, a high score for alcohol abuse, then the module 258 would alert the Administrator to a heightened risk of suicide.

The Decision Support Module for Ordering Additional Tests 270 associates assessments on multiple diagnostic tests with one or more conclusions about the additional screening or diagnostic tests to be performed. For example, an assessment of “ruminative, anxious, and agitated depression,” may be associated with a recommendation for a structured clinical interview for anxiety.

In some embodiments, decision support services are employed 270 to identify possible relevant additional tests. In some embodiments, when additional tests are recommended 272, the Administrator will be provided 274 with those recommendations. In some embodiments, the recommendations will be shown on a display screen. In some embodiments, the recommendations are provided to the Administrator using another means. In some embodiments, the Administrator elects to accept, reject or change those recommendations 276. In some embodiments, if any of the recommendations are accepted, then the Administrator can order those tests 216 and begin a new cycle of testing. In some embodiments, accepting the recommendation results in those tests being automatically ordered and/or administered without further request by the Administrator. In some embodiments, the recommended tests include a mix of screening and diagnostic tests. In some embodiments, if screening tests were recommended, then they will be administered 220; if no screening tests were recommended, then the recommended diagnostic tests would be administered 250 instead. In some embodiments, if the recommendations are rejected, then screening is completed 282. In some embodiments, if the Administrator chooses to modify the list of recommended tests 278, then the modified list becomes the new set of tests to be administered 280.

In some embodiments, once the front-end of the system 200 receives the appropriate diagnostic tests from the back-end of the system 200, the front-end displays the diagnostic tests on the GUI and the test-taker interacts with the GUI 252 to respond to various test items and test stimuli. In some embodiments, the diagnostic tests are administered using some other user interface. In instances where the decision support system recommended one or more diagnostic tests 230, the decision support system 200 may in some embodiments provide In some embodiments, the Administrator has the option of creating their own order set of tests for a particular symptom, condition, disorder, disease or diagnosis. In another embodiment, order sets of tests may be created by others or supplied as part of the decision support system. In some embodiments, an order set includes, for example, some (or none) of the recommended diagnostic tests as well as lists of other tests (or previously created order sets of tests) that can, for example, be selected from a drop-down menu (e.g., all the available tests to screen for depression for patients in a primary care setting can be lists in a drop down menu of the GUI and the Administrator can select diagnostic tests accordingly).

In some embodiments, the test-taker's responses from the diagnostic test are transmitted to the back-end of the system 200 upon test completion or during the test and then scored and interpreted 254 by the decision support system for test interpretation. In some embodiments, a test may be suspended and resumed later. In some embodiments, a test may be abandoned or terminated prior to completion, and the incomplete test may be ignored, or the partial results may be used. In some embodiments, the results of the diagnostic test are stored in a test results database 225. In some embodiments, the results of the diagnostic test including one or more of the following: questions asked, responses, administrator information, the type or name of the test or the like. In some embodiments, the test results database 225 includes one or more of the following: personal or demographic information of the test-taker (e.g., age, gender, etc.), a listing of the other tests taken by the test-taker, temporal or environmental information related to the test-taking, any screening tests taken and/or responses thereto, and/or other relevant data related in any way to the diagnostic test. In some embodiments, the elapsed time a patient or client takes to answer a question is recorded. In some embodiments, some data collected from vital signs monitoring, such as, pulse or heart rate variability is recorded. In some embodiments, the test questions are presented on one electronic device, the test-takers responses are collected on another electronic device, and psychological data (e.g., heart rate) is captured using yet another electronic device.

In some embodiments, including the assessment of criminal defendants, analysis of real-time audio and/or visual monitoring and/or recording is conducted. In some embodiments, this analysis includes one or more of voice stress analysis when answering an examiner's question, eye gaze, and analysis of emotion expressed on the face and analyzed with facial emotion analysis systems. In some embodiments, some or all of the previous information is recorded and correlated with the question being answered at that time. In some embodiments, the test results database records can be copied to a test results warehouse. In some embodiments, the test results warehouse is one or more of a longitudinal clinical data repository, a data warehouse, a knowledge-base, a de-identified data warehouse, and/or other persistent storage system. For example, a criminal defendant or suspect may be interviewed by a psychologist and the defendant's voice and facial expression is recorded and analyzed with regard to the content of his or her speech. The defendant may by physiologically monitored during the interview, with measures of pulse, respiration, heart rate variability recorded and correlated with verbal and non-verbal measures acquired during the interview.

In some embodiments, the data repository or warehouse 227 is used for basic, clinical and translational research including comparative treatment effectiveness research, prospective cohort studies and randomized controlled clinical trials. For example, military service members during pre-deployment basic training are assessed for resilience and vulnerability to stress, cognitive functioning, psychosocial functioning and so on. All the military service members in basic training form a “cohort,” a group that is followed over time, from an initial baseline assessment in which they have not been exposed to combat stress, through deployment and post-deployment. The system provides predictive analytics regarding which service members at pre-deployment are most vulnerable to PTSD, Depression and Substance Abuse. Moreover, when a soldier does develop Posttraumatic Stress Disorder, following a comprehensive biopsychosocial assessment, that soldier can be monitored during treatment and an outcome evaluation, including an assessment of benefits and costs can be conducted at the termination of a treatment episode. In addition, soldiers can be matched on baseline functioning and randomly assigned to various evidence-based treatments. The system can use the same standardized and comparable tests from pre-deployment, to post-deployment to treatment in the Veteran's Health Administration, to assessment for disability across time, across individuals and across settings to enable the Military Health Service and the Veterans Health and Veterans Benefits Administration to become “learning health care organizations” in which data routinely collected during clinical care can populate clinical data repositories to develop cumulative knowledge about how to treat—and ultimately prevent—Posttraumatic Stress Disorder, and other mental disorders.

The routine collection of assessment and treatment data applying the same methodology can be used to evaluate cognitive impairments in the Medicare population. With the integrated comprehensive single source capability described herein, new Medicare recipients could be evaluated, a baseline of cognitive functioning established and then patients can be monitored regarding their cognitive functioning from a pre-disease baseline to the onset of cognitive impairment. At the onset of cognitive impairment, patients would be randomized into different evidence-based treatments and new emerging treatments for reversing cognitive impairment, including neuroprotective drugs in clinical trials, aerobic exercise and cognitive training programs. The patient's response to treatment would be monitored and the outcome of the treatments would be compared. The system described herein makes possible the use of information routinely captured during health care evaluations for use in clinical research, including the testing of alternative treatments for Alzheimer's disease, neurodegenerative disorders and other dementias.

In an embodiment, after at least one diagnostic test is received by the back-end of the system 200 and scored 270, the decision support system (or other program of the back-end of the system 200) may recommend 272 and report to the Administrator 274 one or more additional diagnostic tests. In some embodiments, these additional test(s) are for differential diagnosis. In some embodiments, the Administrator may accept, reject or change 276 those recommendations, which can then be selected, ordered, administered, scored, interpreted, and/or stored in a manner comparable to the previously administered diagnostic test(s).

All scored and interpreted diagnostic test results may be transmitted to the front-end of the system 200 and reported to the Administrator and test-taker in some user interface 256. In some embodiments, the report is formatted into two types of document: one document with clinical interpretations for use by Administrators and the second document with interpretations for use by the patient, person, family, caregiver or the like. In some embodiments, resources links to educational resources and/or digital or print copies of the knowledge resources. In some embodiments, the Administrator (or other clinician) and the test-taker can then collaboratively decide on an appropriate treatment, rehabilitation and/or prevention plan based on the results and/or recommendations provided by the system 200. In some embodiments, the Administrator determines the appropriate treatment, rehabilitation and/or prevention plan based on the results and/or recommendations provided by the system 200.

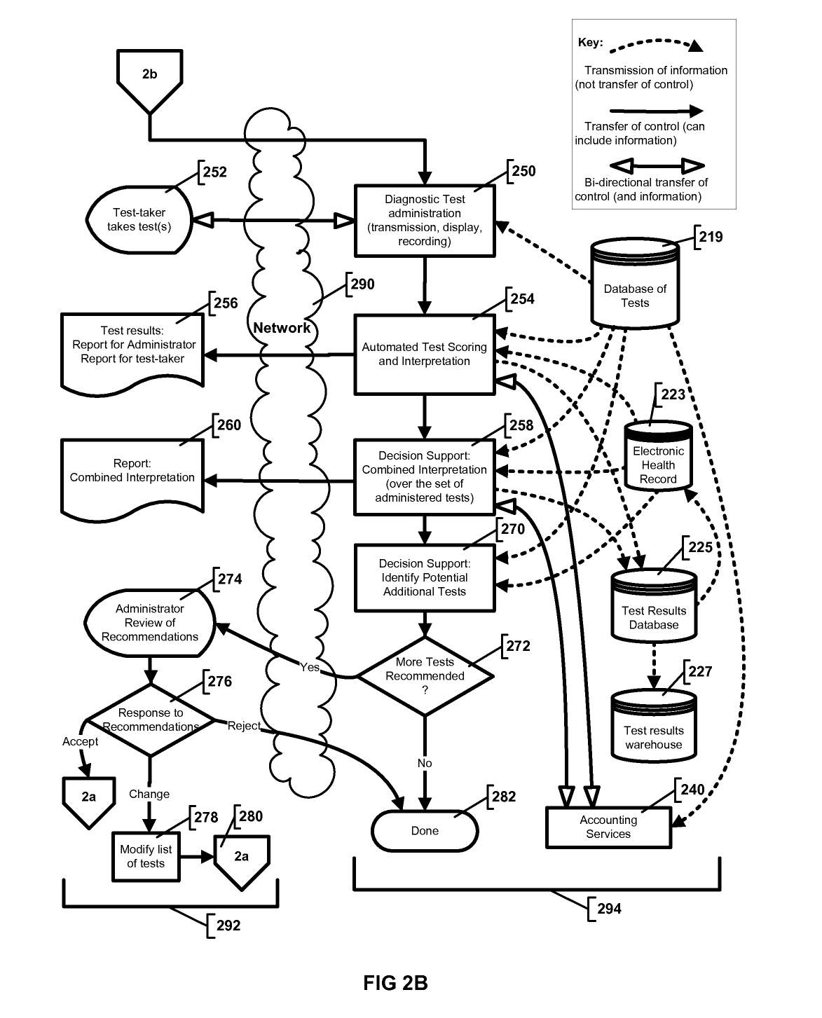

FIG. 3 is an example screen shot 300 of a test administration screen, in which test questions are presented to the test-taker, along with optional test instructions and response choices. In some embodiments, a question 314 and a number of response boxes 316 are displayed via a GUI on a display device (or otherwise presented). In some embodiments, test item instructions 312 appear near or before the displayed test item 314. In some embodiments, optional overall instructions 310 appear at the top or previously. In some embodiments, the test-taker may signal 320 to end the test before all of the questions have been answered. In some embodiments, the test-taker may signal 322 to temporarily interrupt or suspend test administration.

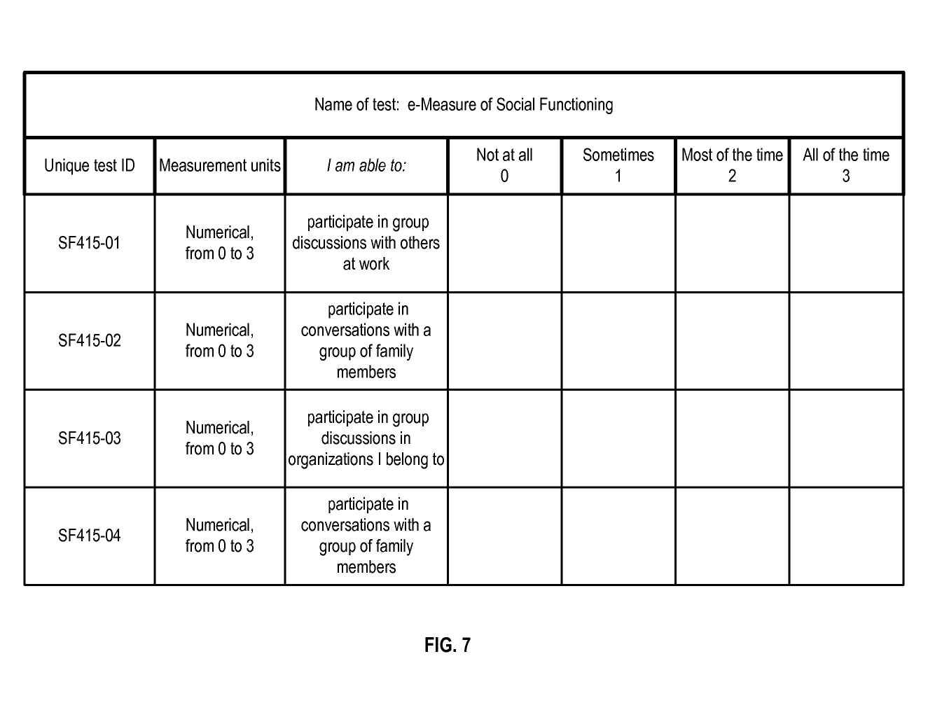

Additional examples of test questions are shown in FIG. 7. The test questions illustrated in FIG. 7 can be administered to the test-taker electronically in any manner discussed above with respect to FIG. 2.

FIG. 4 is a schematic block diagram of a process for selecting screening tests 400, which is implemented by a decision support system (e.g., system 200 of FIG. 2). The screening test process 400 involves communication of the front-end of the decision support system 492 and the back-end of the decision support system 494 via a network 490. The network 490 is similar in operation and function to the network 290 illustrated and described in FIG. 2. The front-end system 492 and the back-end system 494 are similar in structure, operation and function to the front-end system 292 and back-end system 294 illustrated and described in FIG. 2, respectively.

The screening test selection process 400 can be implemented by the decision support system when an Administrator is undecided regarding which diagnostic test to administer to the test-taker. Said another way, the Administrator can initiate the screening test selection process 400 when s/he needs assistance in selecting a diagnostic test for the test-taker. In instances where the Administrator knows which diagnostic test to administer to the test-taker, the screening test selection process 400 can be bypassed and the diagnostic test can be immediately ordered and administered to the test-taker (see, for example, blocks 204 and 230 in FIG. 2A).

In some embodiments, the screening test selection process 400 begins after a patient has been selected and decision support for screening test selection has been requested (as described in FIG. 2, block 208).

In some embodiments, at block 404, the Administrator has the option to enter or input words and/or phrases or a narrative representing symptoms noted by the patient, observed by the clinician and/or reported by other available sources. In some embodiments, the test-taker may enter such words and/or phrases or a narrative. In some embodiments, both the Administer and the test-taker may each enter words or phrases or a narrative. In some embodiments, additional authorized individuals may also enter words and/or phrases or a narrative. In some embodiments, the words and/or phrases include the signs and symptoms, or include a narrative describing the signs and symptoms. In some embodiments, the input includes conditions, diseases, or other descriptions of the patient or test-taker. In some embodiments, the words and/or phrases or narrative are transmitted to the decision support system shown at block 406. In some embodiments, the decision support system can access or include phrase-matching terminology software configured to match the words and phrases against a data dictionary and/or to convert common words or phrases to matching controlled clinical vocabularies, terminologies, taxonomies and diagnostic classifications (e.g., SNOMED, UMLS, the World Health Organization International Classification of Diseases (ICD-9, 10, 11), World Health Organization International Classification of Functioning, Disability and Health, the Diagnostic and Statistical Manual of the American Psychiatric Association and the American Psychological Association Dictionary of Psychology, and their successors or predecessors, and the like. In some embodiments, these terminologies are stored in a database 407. In some embodiments, in step 408 the Administrator's entries are compared with the dictionary and the terminology services to determine whether there are words or phrases for which there are no corresponding entries in database 407. In some embodiments, if there are unmapped terms, then the unmatched entries are re-displayed 410 for the Administrator. In some embodiments, the Administrator has the option of examining the unmatched entries 410 and then selecting 404 words or phrases from the controlled vocabularies that contain the meaning of the previously unmatched words or phrases. In some embodiments, the Administrator is prompted 404 to correct or revise the entries that were identified as unmatched. In some embodiments, the updated entries are then re-submitted 404 and re-evaluated by the phrase-matching terminology software 406.

In some embodiments, when all entries have been mapped to controlled vocabularies (or are otherwise matched or dropped 406), the decision support system 416 analyzes the entries to determine which diagnostic issues are probable or possible and then identifies one or more screening tests to recommend 420. In some embodiments, other available health information about the patient 403 is used by the decision support System 416. In some embodiments, the system includes a database 417 that stores neuropsychological and psychological screening tests upon which the decision support system can in part base its selection. In some embodiments, the list of suggested screening tests is forwarded from the back-end of the system to the Administrator at the front-end of the system 420.

In some embodiments, the decision support system can implement one or more algorithms to determine the list of screening test(s) to recommend. The aforementioned processes can be performed by the system in any one of the manners illustrated and described elsewhere herein.

FIG. 5 is a schematic block diagram of an embodiment of a process for administering a test, which may be used by a decision support system (e.g., system 200 of FIG. 2). FIG. 5 provides further details and variations of embodiments related to the scoring and interpretation of the tests administered. Network 590 performances the comparable role to Network 290 of FIG. 2, including its various variations.

In some embodiments, the process of FIG. 5 begins when the test-taker (or Administrator) logs 502 into the decision support system in any of the manners discussed herein. In some instances, the test-taker may not have completed all of the diagnostic or screening tests ordered during his or her last session (i.e., the last time he or she was logged onto the system). In these instances, when a test-taker next logs into the system 502 or is identified by the Administrator to the system, the system may automatically search for and determine whether there are any tests that remain to be administered to this person. In some embodiments, those tests are ordered 504. In some embodiments, a test may be ordered using its associated standardized test code, and then retrieved from the test database 507 using that code or an internal representation of that code or a corresponding lookup code.

As indicated in FIG. 5, in some embodiments, the system includes a testing engine 508. In some embodiments, the testing engine can be configured to display (or otherwise present to the test-taker) one or more test questions (or items) on the test-taker's display device (or other suitable interface) 510 at the front-end 592 of the system. The testing engine may be configured to transmit and/or display one or more test items or questions at a time for the test-taker to review and respond to. In some embodiments, the testing engine presents one item or question to the test-taker, and waits for a response 512 before providing the next item or question. The testing engine can transmit and/or display test items or questions to the test-taker in any suitable manner and also receive responses in any suitable manner. The responses can be transmitted back to the test engine one at a time, in groups or at the completion of the test. Although the test is illustrated in FIG. 5 and described as being automated and electronically administered, in another embodiment, the test (or at least one of the test questions or items) can be administered in a semi-automated or manual manner (e.g., test administration using a form for optical scanning). This processing sequence is repeated until all test items have been presented and/or all responses have been recorded.

In some embodiments, information is transferred to the testing engine 508 from any of a variety of physiological sensors 506, such as but not limited to heart rate, heart rate variability and blood pressure. In some embodiments, information is transferred to the testing engine 508 from sensors of any of a variety of neurobiological measures or other biomarkers, for example, blood levels of cortisol, a stress hormone. In some embodiments, information may be transferred to the testing engine 508 from neuroimaging studies. Alternative embodiments may combine the item- or question-based testing and other information sources disclosed above in any combination. In some embodiments, the above information is correlated with the question being presented or answered. In some embodiments, the above information is recorded but by a component of the overall system 200 other than the testing engine, such as a specialized component not previously identified.

In some embodiments, when each test is completed, the testing engine passes the responses to a test-scoring module 514 at the system's back-end 594, where a test is scored automatically. In some embodiments, scored tests are stored in the test results database 515, and also forwarded to the test interpretation module 516, where the scores are interpreted or otherwise processed by one or more stored interpretation programs. The aforementioned processes can be performed by the system in any one of the manners illustrated and described elsewhere herein In some embodiments, tests that have been scored are reported to Accounting Services 540, for invoicing or other accounting purposes described herein. In some embodiments, a test is manually scored and the scores are entered into the system. In some embodiments, the test interpretation module 516 produces a test interpretation report 518 concerning each test for the Test Administrator. The system can check whether tests remain to be administered 524 and, if so, the next test is ordered 504 and processing proceeds from there. In one embodiment, after all tests have been administered, decision support 526 provides an integrated interpretation of those tests results 528. In one embodiment, that decision support 526 uses data from an electronic health record 519. In one embodiment, that decision support 526 uses data from educational, military, forensic, public health and other sources. Following administration of the last test and clinical decision support for integrated interpretation, the test administration is completed 530. In some embodiments, the test scores and interpretations are saved to the test results database 515. In some embodiments, the test scores and interpretations are stored in the test results warehouse 517. In some embodiments, data-mining algorithms applied to this warehouse 517 provide the ability to improve any of the decision support algorithms For example, the clinical decision support module related to the assessment of depression and suicide risk contains measures for predictors of increased risk for suicide, such as Major Depressive Disorder, Alcohol Use Disorders, Traumatic Brain Injury and personality traits related to impulsivity. The decision support system models an expert's knowledge in assigning different levels of significance to these predictors, for example alcoholism doubles or triples the risk of suicide for depressed patients. In a Data Mining application, all the information about depression, alcohol use and many other factors are entered into the database. The Data Mining application combines some or all of the measures that predict increased suicide risk after a group of patients is identified with increased suicide risk who either made suicide attempts or committed suicide. The information empirically derived is then used to improve the prediction algorithms in the decision support system. For example, if it is found empirically that depression following loss of a spouse and alcoholism dramatically increases suicide risk that information can be reflected in new decision support algorithms.

In some embodiments, one or more of the test results database 515 or the test results warehouse 517 or the current results of tests administered is used to make recommendations 528 to the Administrator (or the clinician) regarding differential diagnosis, additional testing and resources for patient and clinical to produce a treatment, rehabilitation or prevention plan.

In some embodiments, the list of ordered tests is checked 524 to determine whether all tests have been administered, and if there are tests that have been selected but not yet administered, then one of those tests are ordered 504 (unless already ordered, in which case one such test is chosen) and the test administration process 500 is continued with the that test 508. In some embodiments, if all tests have been completed, then test administration is also complete 530.

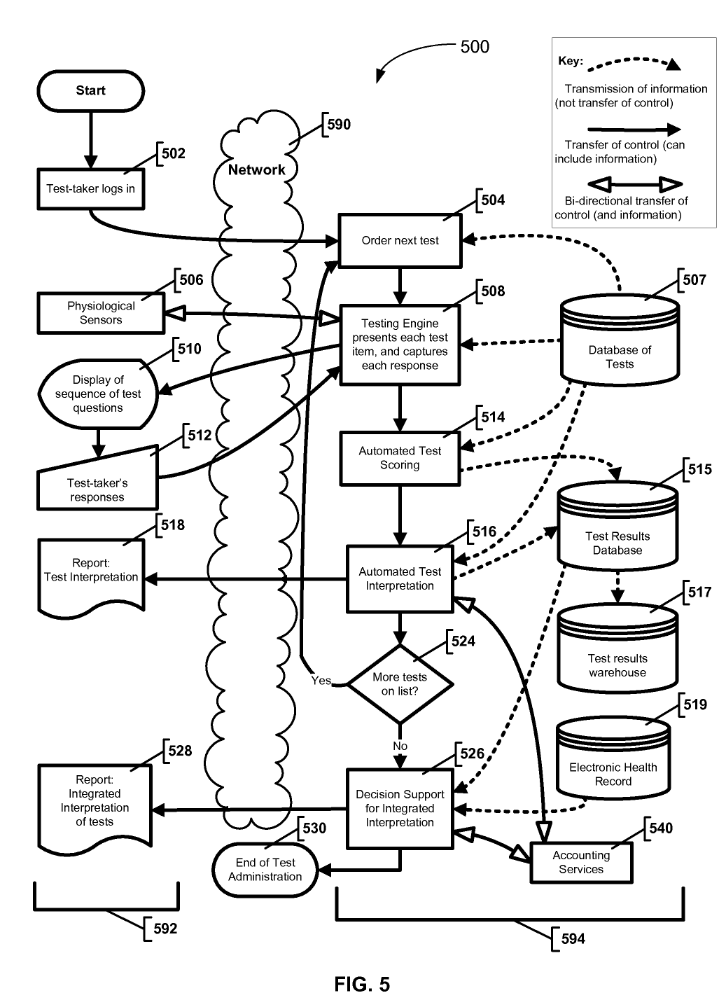

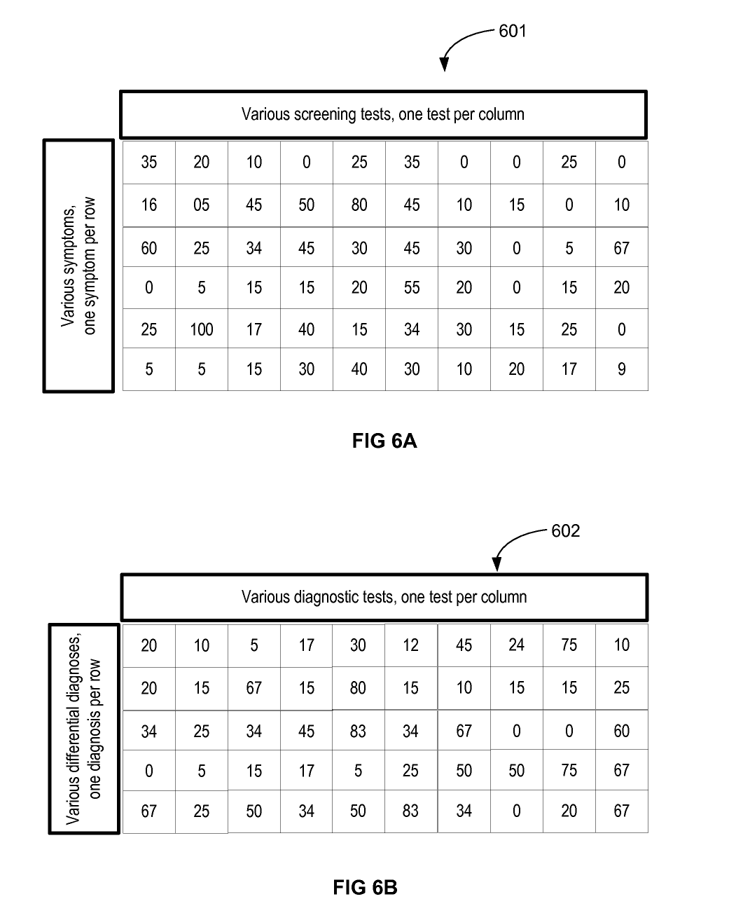

FIG. 6A is a schematic illustration of a screening test table 601 that can be used by a decision support system. The table 601 can be used, for example, by any of the systems (or the processes therein) described herein to determine the appropriate screening tests to select or suggest to the Administrator (e.g., a clinician) based on a test-taker's list of symptoms. The symptoms are matched to particular diagnoses and screening tests for clarifying the likelihood of diagnoses. FIG. 6B is a schematic illustration of a diagnostic test table that can also be used by the decision support system. The table 602 can be used by any of the systems (or the processes therein) described above after screening tests have clarified the range of possible conditions, impairments, conditions, diseases and disorders; more precise differential diagnosis can be accomplished from the more defined list of diagnostic categories.

Referring now to FIG. 6A, for each available screening test, the process employed by the decision support system (e.g., a test-ordering process) assigns a weight to each term in the list of controlled vocabularies, which represents the contribution of that symptom or observation to the value of administering that screening test. Thus, if there are N tests and M controlled vocabulary terms, then for each test Tᵢ, for i=1 . . . N and each of the j terms j=1 . . . M, there is a weight, Wᵢⱼ given to the j^{th} term that expresses that term's contribution (or weight) towards a recommendation of using that test Tᵢ. A test is recommended if, for the subset of the Wⱼ possible terms that were selected by the clinician, ΣWᵢⱼ, is greater than some threshold (ΣWᵢⱼ≧threshold). Said another way, each term Wᵢⱼ is multiplied by Sⱼ, where Sⱼ is equal to 1 if term Wⱼ had been selected by the clinician, or 0 if it had not been selected, resulting in the test selection criteria ΣSⱼWᵢⱼ≧some threshold. The threshold is related to the weights, and, in this embodiment, is set so that the threshold is 100, that is, test Tᵢ is recommended if ΣSⱼWᵢⱼ≧100.

Thus, for example, if symptoms are reported matching those listed in the 2^{nd} and 4^{th} row of the symptom list, then the screening test associated with the 5^{th} and 6^{th} columns would be recommended, as the sum of the weights in the two indicated rows for the 5^{th} column and for the 6^{th} column, add up to at least 100. The other tests (columns) would not be recommended, as their weight totals for the two symptoms sum to less than 100. The same process applies for the table 602 illustrated in FIG. 6B.

As previously discussed, FIG. 7 shows examples of test questions that a decision support system can use and store.

While various embodiments of the invention have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

In some embodiments, the system may be used for interpreting a plurality of tests individually and integrating multiple test results, examinations and interviews to facilitate decision making for screening, diagnosis, treatment and prevention of chronic diseases related to psychological factors and lifestyle behaviors, such as diabetes and cardiovascular disease. For example, diabetic patients who are depressed are less likely to exercise and reduce calorie intake; the decision support system could recommend specialized services, for example, group therapy for depression or social support groups for exercising, that can improve adherence to lifestyle modification in diabetic or pre-diabetic patients.

In some embodiments, the decision support system provides automated workflows, business processes and user interfaces that assist professionals with selecting a plurality of tests for computer-based administration, scoring, transmission, interpretation and/or reporting. In some embodiments, the decision support system provides an automated workflow for assisting professionals in the interpretation of individual tests and for integrating data from multiple tests to make a decision for one or more of the following: a particular patient, job applicant, disability claimant, personal injury plaintiff or criminal defendant. For example, predictors of emotional stability, including good social support and the personality trait of conscientiousness are broadly predictive of resilience to stress in high-stress occupations like military combat, air traffic control, police and civilian first responders. The system can be used to create a pre-deployment baseline as in the example of military personnel and employees can be followed over time and interventions can be developed to prevent or preempt stress disorders in trauma-exposed individuals.

In some embodiments, the decision support system provides automated workflows, business processes and user interfaces for assisting professionals (e.g., Administrators) with conducting semi-structured interviews, for example, using the Clinician Administered Posttraumatic Stress Disorder Scale, and generating categorical and numerical ratings for transmission, scoring, interpretation, reporting and storage. For example, the Clinician Administered Posttraumatic Stress Disorder Scale, the “gold standard” for assessing Posttraumatic Stress Disorder, can be accessed by a clinician on a computer or mobile device, the interview questions presented, the ratings for frequency and severity of symptoms recorded, for example the frequency and severity of nightmares following a trauma, and quantitative scores for each of the dimensions of Posttraumatic Stress Disorder as well as a definitive diagnosis of Posttraumatic Stress Disorder can be recorded within minutes after the interview is completed. The use of an automated system for the assessment of Posttraumatic Stress Disorder that was standardized and provided comparable data no matter where the interview was conducted would dramatically improve the knowledge base about evidence-based treatment for Posttraumatic Stress Disorder.

In some embodiments, the decision support system provides automated workflows, business processes and user interfaces for audiovisual, biometric and/or temporal recording of an individual's responses to test questions, to interviewer questions, and/or to test stimuli. For example, the decision support system can provide audiovisual recording, and/or monitoring of the pulse and/or heart rate variability during a forensic psychological assessment of a criminal defendant (i.e., the test-taker).

In some embodiments, the decision support system performs one or more of the following functions: test selection; test answer interpretation or test score interpretation; test integration (e.g., integrating multiple tests with additional information about the individual to provide assistance to clinicians with diagnosis and treatment, rehabilitation and prevention planning and case monitoring and treatment outcome evaluation); and assistance to professionals evaluating individuals for suitability for employment and assistance to forensic experts for evaluations in civil and criminal litigation. Such functions can be fully or partially automated by the decision support system.

The decision support system can also perform or otherwise assist in clinicians with planning treatment, rehabilitation and prevention for chronic diseases and for measuring a patient's adherence to treatment, including diet and/or exercise, or for measuring the treatment effectiveness, outcomes, benefits or costs for a particular individual.

In some embodiments, the decision support system provides for one of more of the functions of the assessment of vocational functioning, suitability for employment, fitness-for-duty and job performance. In some embodiments, the system provides aggregation and analysis of data from a sample or population for evaluating the benefits, outcomes, quality and value of employer sponsored health promotion and wellness programs and other health and human services.

In some embodiments, the system 200 is used to assess, monitor or otherwise evaluate patients (or other test-takers) that previously lost consciousness or are presently unconscious due to a concussion or similar condition. In one embodiment, an Administrator or another qualified individual can order the appropriate neurobehavioral tests for the patient and then administer the test to the patient once the patient regains consciousness. Alternatively, the test can be scheduled and administered to the patient at a future time when the patient is conscious and medically stable. In this manner, the system allows tests to be “pre-ordered.” The decision support system can transmit the test results and/or any other relevant data to, for example, a field hospital, or a military or civilian hospital. The decision support system can further coordinate repeat administrations of neurobehavioral and psychosocial tests with scheduling for neuroimaging studies (for example CT scans and MRIs of the brain). In other words, the decision support system can schedule (or otherwise prompt an Administrator to schedule) the patient or test-taker to repeat the test(s) and to take an imaging study. The testing and imaging can be repeated as many times as needed until, for example, the patient makes a full recovery. In some embodiments, the decision support system and the data stored therein is accessible to third-party physicians so that they can provide assistance with screening, assessing, and/or diagnosing the patient. The decision support system can perform the above process (or any portion thereof) to facilitate evidence-based treatment for concussive injuries or traumatic brain injuries.

In some embodiments, the system can perform or otherwise aid in the assessment of concussion and traumatic brain injuries that occur as a result of military combat, motor vehicle accidents, or high school or professional sports (e.g., football). For example, a psychologist, army medic or navy corpsman, or emergency medical services personnel can use the system to evaluate a patient (or other test-taker) following a loss of consciousness that resulted from an injury to the brain.

In some embodiments, the system is configured to perform a neurobehavioral, psychosocial, and/or biomedical assessment of a patient (or other test-takers) with an injury (e.g., a traumatic brain injury), and to then follow the patient over time with repeat testing. In some embodiments, the patient assessed by the system does not have a physical injury but may suffer from some other ailment or condition, such as depression. The system can follow up with these patients or test-takers in the same manner—i.e., scheduling and/or obtaining data from repeat testing. Such repeat testing and the data obtained therefrom can be used in clinical and translational research, in comparative treatment effectiveness studies, and in evaluations of outcomes, benefits, costs, quality and value of the health care services performed.

In some embodiments, the system can be used to assess, monitor or otherwise evaluate individuals in the civil and/or criminal justice systems. For example, the system can be used to assess one or more inmates in prison. In some embodiments, the system is configured to track the inmate(s) as s/he moves from one institution to another. The system can maintain a record of the tests that were administered to the inmate throughout the duration of his incarceration (even if, for example, the tests were administered at a different institution from which the inmate currently resides). These records can be used to inform decisions about treatment and case management.

The system can also be used to assess or aid in the assessment of criminal defendants prior to, during, or subsequent to trial. For example, the system can be used to determine if a defendant has diminished mental capacity, presents a suicide or violence risk, or suffers from a mental illness, such as schizophrenia. The results generated by the system can be used by the court or the parties of the trial, for example, to prove or disprove the defendant's culpability, to prove or disprove the defendant's ability to stand trial, or for sentencing. The results generated by the system can be used by decision makers in the criminal justice system to determine competency to stand trial, mitigating factors related to sentencing, and other legal issues.

Furthermore, the system can be used to evaluate an individual or party involved in a civil litigation. For example, in a personal-injury litigation, the system can be used to determine whether a party suffers from impaired functioning or emotional distress as a result of another party's alleged conduct. The system can further determine the extent to which the accusing party is functionally impaired as a result of the accused party's conduct.

In some embodiments, an improved version of the system is created by utilizing data from a longitudinal clinical data repository or data warehouse for mathematical modeling, predictive analytics, data mining, business intelligence and other methods for using aggregated data to improve decision support algorithms for selecting, processing and interpreting tests, which leads to continuous quality improvement in test selection and interpretation for, for example, future patients. As additional data is obtained, they are used to make associations that can improve the predictive accuracy of the various decision-making modules described herein. In other words, the decision support system is a “learning” system—the accuracy of tests for screening, assessment and diagnosis are continuously adapting and improving. The quality and cost-effectiveness of particular tests (e.g., test for detecting particular medical and mental conditions, diseases and disorders) is thereby also continuously improving.

In some embodiments, the system is configured to be accessed by the test-taker. For example, in some embodiments, the test-taker can access the system and order a test without the assistance of an Administrator. In some embodiments, the system is configured to administer the test to the test-taker. In other words, the test-taker can access the system and take a test without the assistance of an Administrator. In this manner, the test-taker can take the test from any location (e.g., at home) and/or does not need to be in the presence of an Administrator. In some embodiments, the system is configured to provide the results of the test directly to the test-taker. For example, upon completion and scoring of the test, the system can be configured to display the tests results to the test-taker via a GUI (i.e., via the front-end of the system). In some embodiments, the system is configured to mail or electronically deliver the results to the test-taker (e.g., via text, email, and/or the like). In some embodiments, the system is configured to forward or otherwise provide the test results to a third-party (e.g., the test-taker's medical provider or an Administrator) upon request of the test-taker.

In some embodiments, the front-end of the system (e.g., front-end system 292 shown in FIG. 2) or at least a portion thereof can include software, programs or modules that are implemented via an iPad® application, an Android® application, or other like tablet or smartphone applications. In some such embodiments, this application is used to track the test-taker's diet and exercise. In some embodiments, the front-end of the system is configured to transmit the data collected via the application to the back-end of the system (e.g., back-end system 294 shown in FIG. 2). The front-end of the system can send or transmit the data to the back-end of the system in one or more of the following manners: periodically (e.g., at pre-determined intervals), continuously, upon demand from the back-end of the system, upon demand from the test-taker or Administrator at the front-end of the system, when the network is available or when suitable network bandwidth is available, when data is obtained, received, or generated by the front-end of the system, when the cost of transmission at a particular time is below a certain cost threshold (in other words, it is relatively inexpensive or less expensive to transmit during that time as compared to other times), and/or the like.

In some embodiments, the system includes a selection or menu of tests that produce results that identify or suggest the best manner to assist or encourage the test-taker in achieving goals, such as, for example, weight loss goals, improved health, or increased physical fitness. In this manner, the system can be used in fitness or sports-related fields, such as sports medicine. For example, a trainer can use the system and the results of psychological testing to help athletes improve their performance. In some embodiments, the reports generated by the system are configured to provide information to a coach, supervisor, or other individual on how to motivate the test-taker to accomplish a desired goal or task.

In some embodiments, the system is configured to determine (or to generate results that are used to determine) whether a test-taker, who is at risk for a chronic disease (such as diabetes or heart disease), is a good candidate to try a lifestyle intervention to reduce the risk of the potential chronic disease. The system can also be used to determine (or to generate results that are used to determine) whether a test-taker, who already has a chronic disease, is a good candidate for the lifestyle intervention. In some embodiments, the system monitors the lifestyle intervention through various tests and recordkeeping to determine the degree of success of the lifestyle intervention. In some embodiments, a report generated by the system provides information on how to increase compliance for the lifestyle change(s). In some embodiments, a report generated by the system provides information indicating that medical treatment for a chronic disease or condition (or prevention thereof) should not be delayed while a lifestyle change is attempted. In some embodiments, a report generated by the system indicates that medical treatment should not be delayed because the lifestyle change is unlikely to be successful. In some embodiments, a report generated by the system indicates that medical treatment should not be delayed because the medical condition cannot go untreated while the lifestyle change is attempted. In some embodiments, a report generated by the system indicates that medical treatment should not be delayed because the lifestyle change will likely take too long to be sufficiently effective. In some embodiments, a report generated by the system indicates that an attempted lifestyle change has been insufficient to address a (potential or actual) chronic disease or condition and medical intervention should be commenced, continued and/or be modified, as appropriate.

As is apparent, use of the system can provide a test-taker and/or Administrator with a single source for test ordering and order fulfillment (“one-stop shopping”). In other words, the system can provide the test-taker and/or Administrator with all the tools and mechanisms they need for evaluation and assessment. Specifically, the system provides a single source for selecting one or more tests and the ordering, scheduling, administering, and scoring these tests.

In some embodiments, data may be securely transmitted (encrypted, HIPAA compliant) between the front-end system and the back-end system (or between the modules therein) via the Internet or other network.

In some embodiments, the test is scored on a local computer (e.g., at the front-end of the system) in real-time or after the test-taker has completed the test; the results are then transmitted to the back-end of the system and stored. In other embodiments, the test data is transmitted securely over the Internet or an intranet from the front-end of the system to the back-end of the system, and then scored at the back-end of the system. In some embodiments, the test results are stored in a clinical data repository, which can be part of or separate from the decision support system. In some embodiments, the test results are sent to the Administrator.

In some embodiments, the system can include a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

It should be understood that the embodiments disclosed herein are exemplary and that one of ordinary skill in the art may understand a variety of implementations are consistent with this description and that these embodiments do not limit the scope of the invention.

What is claimed is:

1. A non-transitory processor-readable medium storing code representing instructions to cause a processor of a decision support system to perform a process, the code comprising code to:
receive a first signal representing input data from an electronic device, the input data including one or more input terms that describes a functioning of a test-taker undergoing a biopsychosocial assessment;
generate a list of recommended screening tests to administer to the test-taker at an electronic device based on at least one of the input terms;
transmit a first output signal representing the list of recommended screening tests to an electronic device;
receive, from an electronic device, a second signal representing a selection of one or more screening tests from the list of recommended screening tests to administer to the test-taker at an electronic device; and
transmit a second output signal representing at least one of the selected screening tests to an electronic device such that at least one of the selected screening tests is presented on an electronic device and administered to the test-taker at that electronic device.

2. The non-transitory processor-readable medium of claim 1, further comprising code to:
receive, from an electronic device, a third signal representing a response to at least one of the selected screening tests administered to the test-taker;
generate a list of recommended biopsychosocial diagnostic tests to administer to the test-taker at an electronic device based on the response to at least one of the selected screening tests;
transmit a third output signal representing the list of recommended biopsychosocial diagnostic tests to an electronic device;
receive, from an electronic device, a fourth signal representing a selection of one or more biopsychosocial diagnostic tests from the list of recommended biopsychosocial diagnostic tests to administer to the test-taker; and
transmit a fourth output signal representing at least one of the selected biopsychosocial diagnostic test to an electronic device such that at least one of the selected biopsychosocial test is presented on an electronic device and administered to the test-taker at that electronic device.

3. The non-transitory processor-readable medium of claim 1, further comprising code to:
compare each input term from the at least one input term to a plurality of pre-defined terms stored within the decision support system to determine an association between each input term and at least one pre-defined term from the plurality of pre-defined terms, the list of recommended screening tests being generated based on at least one input term when the processor determines an association;
when the processor determines that there is no association between an input term and at least one pre-defined term, transmit a third output signal to an electronic device prior to generating the list of recommended screening tests, the third output signal representing a request to replace the non-associated input term with at least one pre-defined term from the plurality of pre-defined terms.

4. The non-transitory processor-readable medium of claim 1, wherein the list of recommended screening tests is generated based on at least one of the input terms and additional information associated with the test-taker.

5. The non-transitory processor-readable medium of claim 1, further comprising code to:
access a database storing a plurality of screening tests for biopsychosocial assessments, at least one recommended screening test in the list of recommended screening tests being selected by the processor from the plurality of screening tests in the database.

6. A system, comprising:
a validation module configured to receive input data from an electronic device operated by a test-taker during a biopsychosocial assessment, the input data including a plurality of input terms that describes a functioning of the test-taker, the validation module configured to validate the plurality of input terms based on a plurality of pre-defined terms stored within the system; and
an analysis module configured to generate a list of potential biopsychosocial-related issues associated with the test-taker based on at least one input term from the plurality of input terms when the at least one input term is validated by the validation module, the analysis module configured to generate a list of one or more recommended tests to administer to the test-taker during the biopsychosocial assessment based on the list of potential biopsychosocial-related issues generated, the analysis module configured to transmit an output signal representing the list of one or more recommended tests to an electronic device such that the list of one or more recommended tests is presented at an electronic device.

7. The system of claim 6, wherein the validation module is configured to validate the plurality of input terms by comparing each input term from the plurality of input terms to the plurality of pre-defined terms stored within the system, each input term being validated when that input term matches at least one pre-defined term from the plurality of pre-defined terms.

8. The system of claim 7, wherein, when an input term from the plurality of input terms is not validated, the validation module is configured to transmit a request signal to an electronic device, the request signal configured to prompt that electronic device to present a request to replace that input term with at least one pre-defined term from the plurality of pre-defined terms.

9. The system of claim 6, wherein the analysis module is configured to access additional information associated with the test-taker, the analysis module configured to generate the list of potential biopsychosocial-related issues associated with the test-taker based on the additional information and at least one input term that is validated.

10. The system of claim 6, wherein the analysis module is configured to access additional information associated with the test-taker, the analysis module configured to generate the list of one or more recommended tests to administer to the test-taker during the biopsychosocial assessment based on the additional information and the list of potential biopsychosocial-related issues generated.

11. The system of claim 6, further comprising:
an order module configured to receive a request signal representing selection of one or more tests from the list of recommended tests from an electronic device, the order module configured to transmit data associated with the one or more selected tests to an electronic device in response to the request signal such that the each of the one or more selected tests is presented on an electronic device and administered to the test-taker at an electronic device.

12. The system of claim 6, further comprising:
a test administration module configured to transmit a data signal to an electronic device to initiate administration of a test to the test-taker at an electronic device, the test being selected from the list of recommended tests, the data signal including a representation of at least one question from the test configured to be presented at an electronic device, the test module configured to receive a response signal from an electronic device when a response to the at least one question from the test is input into that electronic device.

13. The system of claim 12, wherein the output signal is a first output signal, the system further comprising:
a selection module configured to generate a list of recommended biopsychosocial tests to administer to the test-taker during the biopsychosocial assessment based the response signal, the selection module configured to transmit a second output signal representing the list of one or more recommended biopsychosocial tests to an electronic device such that the list of one or more recommended biopsychosocial tests is presented at an electronic device.

14. The system of claim 13, wherein the data signal is a first data signal, the system further comprising:
a biopsychosocial test administration module configured to transmit a second data signal to an electronic device to initiate administration of a biopsychosocial test to the test-taker at an electronic device, the biopsychosocial test being selected from the list of one or more recommended biopsychosocial tests transmitted to an electronic device by the selection module, the second data signal including a representation of at least one question from the biopsychosocial test configured to be presented at an electronic device.

15. A system, comprising:
a test scoring module configured to calculate a first test score based on one or more responses to a biopsychosocial test administered to a test-taker, the test scoring module configured to produce a second test score by normalizing the first test score; and
a test interpretation module configured to analyze the second test score and to generate a report including the second test score and a list of recommendations associated with a functioning of the test-taker based on the second test score.

16. The system of claim 15, wherein the biopsychosocial test is a first biopsychosocial test, the report is a first report, the system further comprising:
a combined interpretation module configured to access a third test score that was based on responses to a second biopsychosocial test administered to the test-taker, the combined interpretation module configured to analyze the second test score and the third test score to produce a combined test analysis, the combined interpretation module configured to generate a second report including the combined test analysis and a list of recommendations associated with a functioning of the test-taker based on the combined test analysis.

17. The system of claim 15, further comprising:
a test recommendation module configured to generate a recommendation of one or more additional biopsychosocial tests to administer to the test-taker based on the second test score.

18. The system of claim 15, wherein the test interpretation module is configured to access additional information associated with the test-taker, the test interpretation module configured to analyze the second test score based on the additional information about the test-taker to produce a combined test interpretation, the report generated by the test interpretation module including the second test score and a list of recommendations associated with a functioning of the test-taker based on the combined test interpretation.

19. The system of claim 15, wherein the test interpretation module is configured to access test score data from a plurality of test-takers, the test interpretation module configured to analyze the second test score based on the test score data to produce a test interpretation, the report generated by the test interpretation module including the second test score and a list of recommendations associated with a functioning of the test-taker based on the test interpretation.

20. The system of claim 15, further comprising:
a test administration module configured to receive a data signal from an electronic device indicating completion of a biopsychosocial test administered to a test-taker at an electronic device, the data signal including responses to the biopsychosocial test input into an electronic device by the test-taker.
